(19) United States
(12) Patent Application Publication
(10) Pub. No.: US 2015/0039872 A1
(43) Pub. Date: Feb. 5, 2015

(54) Multiple Signed Filesystem Application Packages

(71) Applicant: Caterpillar Inc., Peoria, IL (US)

(72) Inventors: Caleb Jorden, Peoria, IL (US); Robert F. Schultz, Dunlap, IL (US)

(73) Assignee: Caterpillar Inc., Peoria, IL (US)

(21) Appl. No.: 13/959,400

(22) Filed: Aug. 5, 2013

(51) Int. Cl. G06F 9/445; G06F 21/64; H04L 9/32

(52) U.S. Cl. CPC G06F 8/60; H04L 9/3281; G06F 21/64
USPC 713/1

(57) ABSTRACT

A method and system is provided for file and application management. The method may include configuring a destination system where the method further includes generating a filesystem image including an application file and files necessary for the destination system to execute the application file, generating a cryptographic signature of the filesystem image, transferring the filesystem image and the cryptographic signature to the destination system, cryptographically verifying the filesystem image with the cryptographic signature, and mounting the filesystem image on the destination system in a read-only manner.

### TECHNICAL FIELD

This disclosure relates generally to file and application management utilizing a signed filesystem application package, and more particularly, to file and application management utilizing multiple signed filesystem application packages.

### BACKGROUND

A computer system usually has a filesystem. For example, a traditional UNIX-based filesystem is a hierarchical structure of directories, each capable of containing files and/or sub-directories. When an application program is installed in a filesystem of a computer, the application binaries, libraries and configuration files for the application program are installed in the file system. In particular, each of the application binaries, libraries and configuration files is stored in a corresponding directory in the hierarchical structure of the filesystem. The application package contents are merged with the entire system. When the application program needs to be updated, extensive processes are often required to transfer and verify each of the new files and replace each of the program files stored in various directories in the filesystem with the new files. When the number of applications or a number of computers for the update is large, transferring, verifying and replacing files associated with the update may be time-consuming and difficult. For example, for a device that often executes multiple applications onboard, such as a computer, a smart phone, a mobile device, an engine control module (ECM), or the like, it is difficult to manage and update each of the multiple applications independently without interfering with the filesystem of the device. Moreover, it is difficult to ensure the integrity of the multiple applications.

Certain techniques have been developed to assist a user in managing a file system of a computer. For example, International Patent Application Publication, WO 2011/022388 A1 to Phillips discloses a layered virtual file system including a collection of system data, user data, and virtualized applications so that the file system in a computer can be managed through the layered virtual file system. However, similar to the conventional file system, each of the application binaries, libraries and configuration files is stored in a corresponding layer in the layered structure of the virtual file system. Thus, such a virtual file system does not address issues associated with managing an application program such as transferring, verifying and replacing files of the application program. In fact, the issues still remain regardless of the type of file system.

Accordingly, a mechanism is needed to allow easier management of applications and to ensure the integrity of an application and its various components.

### SUMMARY

One aspect of the disclosure includes a method of configuring a destination system. The method includes generating, via a system, a filesystem image including an application file and files necessary for the destination system to execute the application file; generating, via the system, a cryptographic signature file of the filesystem image; configuring the filesystem image and the cryptographic signature file to be utilized by the destination system; transferring the filesystem image and the cryptographic signature file to the destination system; cryptographically verifying the filesystem image by the destination system; and mounting the filesystem image on the destination system in a read-only manner.

The method may further include generating, via a system, a filesystem image including an application file and files necessary for the destination system to execute the application file, wherein the system is different from the destination system, wherein the destination system includes a Linux-based filesystem, and wherein the application file and the files necessary for the destination system to execute the application file include at least any one of a binary file, a library file, a configuration file; generating, via the system, an identification name of the filesystem image to indicate a version of the filesystem image; cryptographically signing, via the system, the filesystem image; selecting and verifying, on the destination system, a preferred version among a plurality of versions of the filesystem image when the plurality of versions of the filesystem image are present in the destination system; removing, on the destination system, versions of the filesystem image that do not possess a cryptographic signature; cryptographically verifying, on the destination system, the filesystem image against change, due to tampering or corruption, via the cryptographic signature file; mounting the filesystem image into a filesystem of the destination system; integrating the destination system into an Engine Control Module (ECM); executing, on the destination system, the application file located in the filesystem image; preventing the destination system from modifying a content of the filesystem image once the filesystem image is mounted into a filesystem of the destination system; and maintaining an original hierarchical file structure of the destination system while mounting the filesystem image into the filesystem of the destination system.

Another aspect of the disclosure includes a device. The device includes a filesystem including a hierarchical structure of directories, each of the directories capable of including files and sub-directories; an operating system and files necessary for the device to operate the operating system, wherein the files necessary for the device to operate the operating system are stored in at least one of the directories; a filesystem image including an application file and files necessary for the device to execute the application file, wherein an entire content of the filesystem image remains unmodified within the filesystem image in the device; and a processor configured to operate the operating system and further configured to execute the application file within the filesystem image.

The device may further include a processor wherein the processor may be configured to access the application file while maintaining the entire content of the filesystem image unmodified, wherein the processor may be configured to cryptographically verify the filesystem image, wherein the processor may be configured to prevent the device from modifying the filesystem image, wherein the processor may be configured to remove the filesystem image from the device, and wherein the processor may be configured to select and verify a preferred version among a plurality of versions of the filesystem image when the plurality of versions of the filesystem image are present in the device.

Another aspect of the disclosure includes an apparatus, where the apparatus includes filesystem means including an application file and files necessary for executing the application file in a device; means for transferring the filesystem means to the device; means for cryptographically verifying the filesystem means; means for mounting the filesystem means on the device in a read-only manner; and means for maintaining an entire content of the filesystem means once the filesystem means is mounted on the device.

The apparatus may further include means for generating an identification name of the filesystem means to indicate a version of the filesystem means; means for generating a cryptographic signature file of the filesystem means; means for cryptographically verifying the filesystem means with the cryptographic signature file; means for selecting and verifying a preferred version among a plurality of versions of the filesystem means when the plurality of versions of the filesystem means are present in the device; and means for removing non-verified versions of the filesystem means from the device.

### BRIEF DESCRIPTION OF THE DRAWINGS

FIG. 1 illustrates an exemplary destination system according to the disclosure.

FIG. 2 is an algorithm for processing a filesystem image according to the disclosure.

FIG. 3 is an algorithm for processing multiple filesystem images according to the disclosure.

FIG. 4 is an algorithm for processing a plurality of versions of a filesystem image according to the disclosure.

FIG. 5 is a schematic diagram of an exemplary filesystem of a destination system containing a filesystem image according to the disclosure.

### DETAILED DESCRIPTION

Reference will now be made in detail to exemplary aspects, which are illustrated in the accompanying drawings. Wherever possible, the same reference numbers will be used throughout the drawings to refer to the same or like parts.

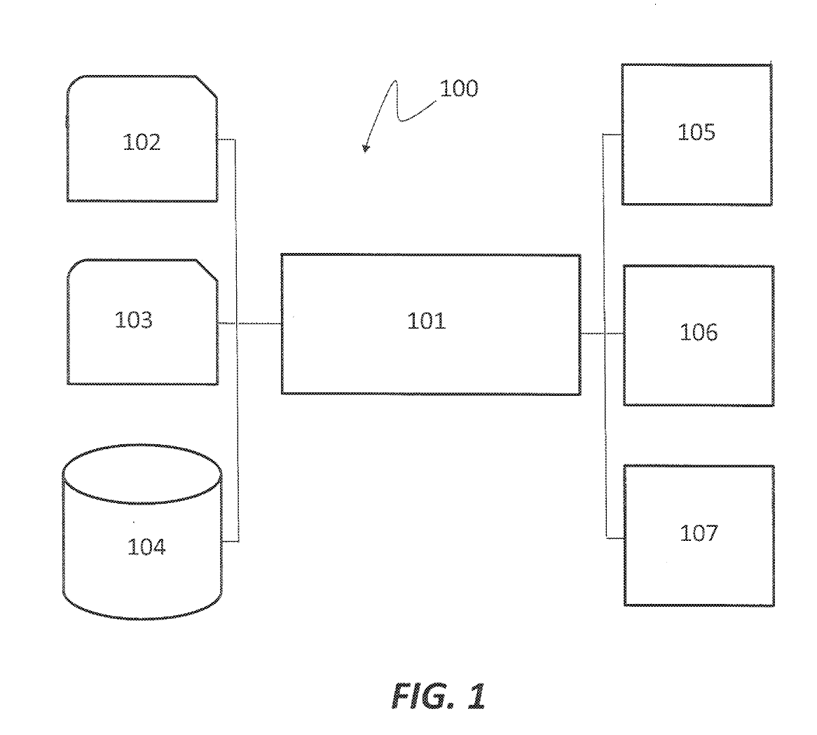

FIG. 1 illustrates an exemplary destination system according to the disclosure. In particular, FIG. 1 illustrates a destination system 100. The destination system 100 may include a processor 101 (or other dedicated hardware), a random access memory (RAM) 102, a read-only memory (ROM) 103, a storage device 104, a console 105, an input device 106, a network interface 107, and the like. It is understood that the type and number of listed devices are exemplary only and not intended to be limiting. The number of listed devices may be changed and other devices may be added.

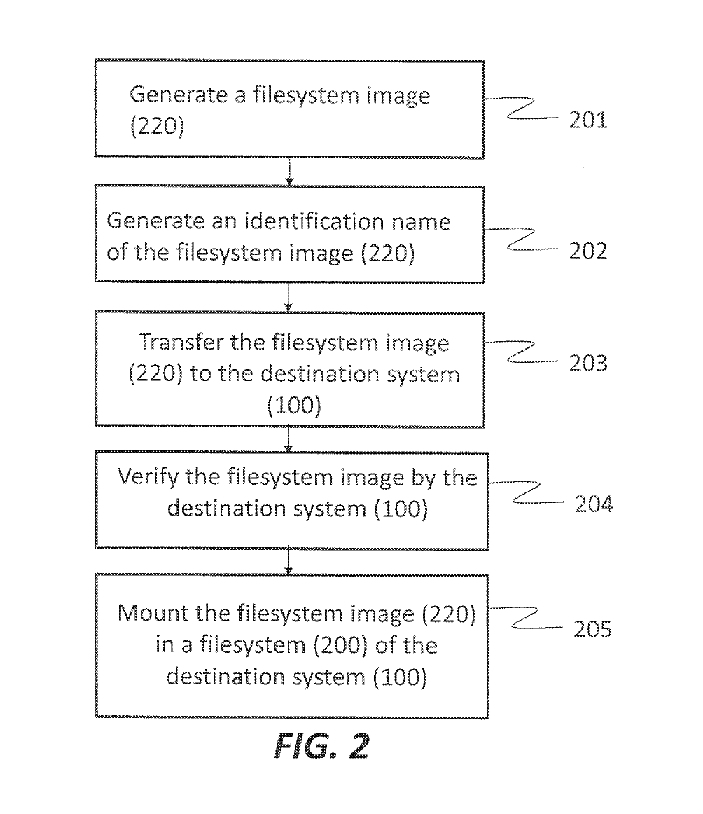

FIG. 2 is an algorithm for processing a filesystem image according to the disclosure. In particular, FIG. 2 is an algorithm for processing a filesystem image 220 according to the disclosure. A filesystem image 220 may include an application file and all the necessary files for the destination system 100 to execute the application file. The filesystem image 220 may be generated as a single package or as an image file (step 201). In particular, the filesystem image 220 may be generated via a separate external device (not shown). Optionally, the separate external device may be different from the destination system 100. The separate external device may be implemented using dedicated hardware. An identification name such as a name and a specified number may be assigned to the filesystem image 220 (step 202).

The filesystem image 220 may be digitally signed when it is generated. In some aspects, the filesystem image 220 may be an application image file having the application name and the corresponding identification number, along with a signature file that may contain the cryptographic signature of the filesystem image 220. In various aspects, the signature file may have the same name and identification number as the filesystem image 220. Optionally, the signature file may include an electronic signature associating the filesystem image 220 with a user. The filesystem image 220 along with the signature file may be transferred to the destination system 100 on which the filesystem image 220 is to be mounted (step 203). The destination system 100 may cryptographically verify the filesystem image 220 with the signature file (step 204). In some aspects, the destination system 100 may cryptographically verify that the filesystem image 220 has not been modified, tampered and/or corrupted. If the destination system 100 successfully verifies the filesystem image 220, the destination system 100 may mount the entire filesystem image 220 into a filesystem 200 of the destination system 100 in a read-only manner (step 205). Once the filesystem image 220 is mounted on the destination system 100, the destination system 100 may not modify any file in the filesystem image 220.

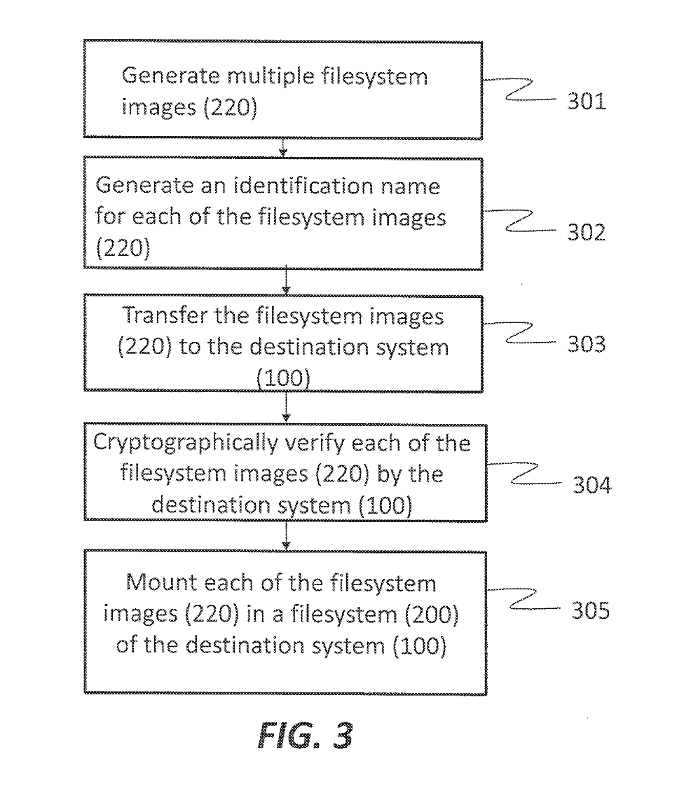

FIG. 3 is an algorithm for processing multiple filesystem images according to the disclosure. In particular, FIG. 3 shows an algorithm for processing multiple filesystem images 220. Multiple filesystem images 220 may be generated where each of the filesystem images 220 may include an application file and files necessary for the destination system 100 to execute the application file (step 301). In particular, the filesystem images 220 may be generated via a separate device (not shown). The separate device may be implemented using dedicated hardware. An identification name may be assigned to each of the filesystem images 220 (step 302). For example, each application may include a logical name such as App1, App2, App3, etc. Each application may be released in a corresponding filesystem image 220 containing the application name and number along with a cryptographic signature file that may contain the signature of the corresponding filesystem image 220 such as: App1_{—}0123456789.1 mg, App1_{—}0123456789.1 mg signature; App2_{—}0123456790.1 mg, App2_{—}0123456790.1 mg signature; and App3_{—}0123456791.1 mg; App3_{—}0123456791.1 mg signature (the numbers and specific names are exemplary).

The filesystem images 220 along with the cryptographic signature files may be transferred to the destination system 100 (step 303). The destination system 100 may access the filesystem images 220 (step 304) and mount each of the filesystem images 220 into a filesystem (200) of the destination system 100 (step 305). During the mounting process, the destination system 100 may cryptographically verify the filesystem images 220 with the corresponding signature files. The destination system 100 may further verify that each of the filesystem images 220 has originated from a trusted source. In various aspects, the filesystem images 220 may be mounted in a standard location.

Optionally, the mounting process may include storing the filesystem images 220 in the destination system 100 and configuring the destination system 100 to access the filesystem images 220. A mounting point may be generated dynamically if needed. For example, in a Unix-based filesystem, following the corresponding application names, the multiple filesystem images 220 may be mounted in the /var/apps/ directory as follows: /var/apps/App1/, /var/apps/App2/, and /var/apps/App3/. The specific names and phrases herein are exemplary only, and any appropriate names and phrases are contemplated and may be used.

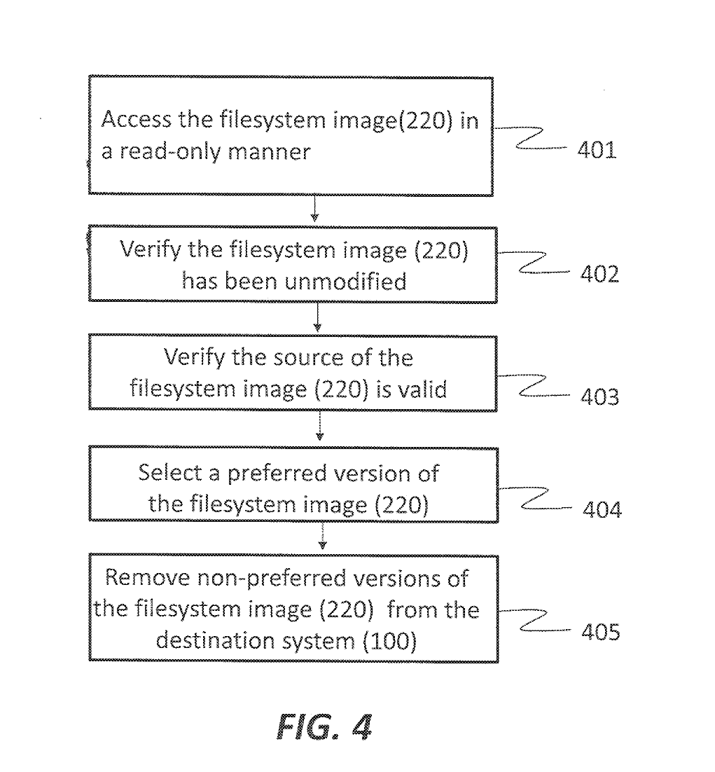

FIG. 4 is an algorithm for processing a plurality of versions of a filesystem image according to the disclosure. In particular, FIG. 4 shows an algorithm for processing a plurality of versions of a filesystem image 220. The destination system 100 may access the filesystem image 220 in a read-only manner (step 401). The destination system 100 may cryptographically verify that the filesystem image 220 has not been modified, tampered and/or corrupted (step 402). The destination system 100 may further verify that the filesystem image 220 has been transferred from a trusted source (step 403).

The destination system 100 may be configured to look for a newer version of the filesystem image 220 when the destination system 100 identifies an out-of-date version of the filesystem image 220. When different versions of the filesystem image 220 are present in the destination system 100, a preferred version of the filesystem image 220 may be selected (step 404). In one aspect, a newer version of the filesystem image 220 may be determined by sorting the names of the different versions of the filesystem image 220. For example, given the two filesystem images, App2_{—}0123456791.1 mg and App2_{—}0123456790.1 mg, the App2_{—}0123456791.1 mg file may be newer according to one approach. Other approaches are contemplated to determine newer versions. In some aspects, other versions of the filesystem image 220 or a filesystem image not possessing a cryptographic signature file may be removed from the destination system 100 (step 405).

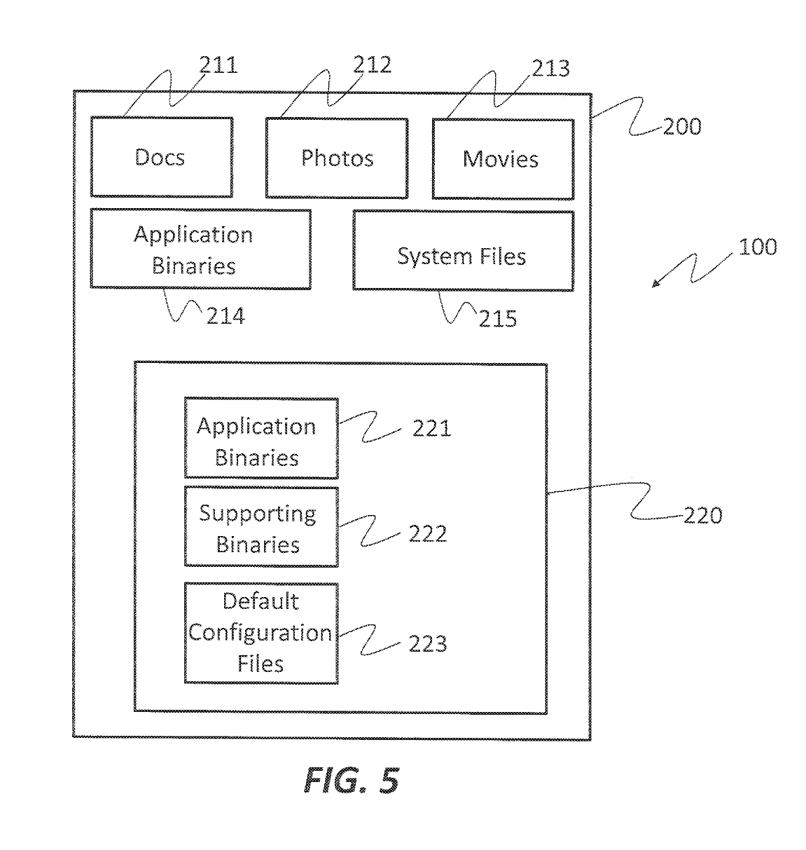

FIG. 5 is a schematic diagram of an exemplary filesystem of a destination system containing a filesystem image according to the disclosure. In particular, FIG. 5 is a filesystem 200 containing a filesystem image 220 within the destination system 100. The filesystem 200 may include a collection of system files 215, application binaries 214, and data files such as document files 211, photos 212, movies 213, and the like. The filesystem 200 may further include the filesystem image 220. The filesystem image 220 may include executables, libraries, configuration files, and the like, such as application binaries 221, supporting binaries 222, and default configuration files 223.

In an aspect, the filesystem image 220 may be located in a directory of the filesystem 200. In some aspects, the filesystem image 220, including its entire contents, may be located in a specified directory of the filesystem 200. In various aspects, the filesystem image 220 may be an image file.

In another aspect, the filesystem image 220 may be configured for use and fully updated with patches, bug fixes, and the like. In some aspects, the filesystem image 220 may include an application file and files necessary for the destination system 100 to execute the application file. Execution of the application file may proceed within the filesystem image 220 without copying the application file and/or the files necessary for the destination system 100 to execute the application file into another directory in the filesystem 200. In various aspects, the contents in the filesystem image 220 may remain within the filesystem image 220 without being copied to another directory in the filesystem 200.

In another aspect, the filesystem image 220 may be configured to disallow or not support modification of its contents by the destination system 100 accessing the filesystem image 220. Operations on selected files of the filesystem image 220 may be performed without copying the selected files to other filesystems mounted in the destination system 100. In some aspects, the filesystem image 220 may configure the destination system 100 to perform required operations without modifying a file in the filesystem image 220 mounted on the destination system 100. In various aspects, the filesystem image 220 may include read-only files.

### INDUSTRIAL APPLICABILITY

Various aspects of the disclosure can be implemented by arrangement of operations, software, firmware, hardware, or a combination thereof. The destination system 100 may be a computer that may include a number of devices including the processor 101 (or other dedicated hardware), the random access memory (RAM) 102, the read-only memory (ROM) 103, the storage device 104, the console 105, the input device 106, the network interface 107 and the like. The destination system 100 may include one or more processors such as the processor 101. It is understood that the type and number of listed devices are exemplary only and not intended to be limiting. The number of listed devices may be changed and other devices may be added.

The processor 101 may include any appropriate type of general purpose microprocessor, digital signal processor, microcontroller, dedicated hardware, or the like. The processor 101 may execute sequences of computer program instructions to perform various processes. The computer program instructions may be loaded into the RAM 102 for execution by the processor 101 from the ROM 103, from a communication channel (wired or wireless), from the storage device 104 and/or the like. The storage device 104 may include any appropriate type of storage provided to store any type of information that the processor 101 may need to perform the processing. In one aspect, the storage device 104 may include a hard disk drive, a removable storage drive, flash memory, a memory stick, or the like. The removable storage device may include a floppy disk drive, a magnetic tape drive, an optical disk drive, a flash memory drive or the like.

The console 105 may provide a graphic user interface (GUI) to display information to users of the destination system 100. The console 105 may include any appropriate type of computer display device or computer monitor. The input device 106 may be provided for users to input information into the destination system 100. The input device 106 may include a keyboard, a mouse, a touch screen, keypad, or other optical or wireless computer input device, etc.

The network interface 107 may provide communication connections such that the destination system 100 may be accessed remotely through computer networks via various communication channels (wired or wireless) and/or communication protocols, such as transmission control protocol/internet protocol (TCP/IP), hypertext transfer protocol (HTTP), etc. The network interface 107 may allow software and data to be transferred between the destination system 100 and external devices. The network interface 107 may include a modem, a network interface, communication ports, a Personal Computer Memory Card International Association (PCMCIA) slot and card, a Universal Serial Bus (USB) connection, a Firewire connection, an Infrared (IR) port, a Bluetooth transceiver, a Wireless Fidelity (Wi-Fi) transceiver or the like.

Optionally, the destination system 100 may include a database. The database may include various databases related to file management, applications and/or any information used by processor 101. The database may include any type of commercial or customized database. The database may also include analysis tools for analyzing the information in the database. The processor 101 may also use the database to determine and store performance characteristics of the destination system 100.

The filesystem image 220 may be generated in a separate external device. Alternatively, the destination system 100 may generate the filesystem image 220 in a specified directory in the filesystem 200. The filesystem image 220 may be digitally signed when it is generated. In one aspect, the filesystem image 220 may be an application image file having the application name and the corresponding identification number, along with a cryptographic signature file that may contain the signature of the filesystem image 220. The filesystem 200 and/or the filesystem image 220 may be based on any and all versions of the following operating systems, including, without limitation, equivalents or derivatives thereof: Microsoft Windows, Unix, Linux, Mac OS X and so on. In one aspect, the filesystem 200 may be a Unix-based filesystem. In some aspects, the filesystem 200 may be a Linux-based filesystem. In various aspects, the filesystem image 220 may be a loopback filesystem in a Linux-based system.

The generated filesystem image 220 may include an application file and all the necessary files for the destination system 100 to execute the application file. In one aspect, the generated filesystem image 220 may include an application file together with all the necessary files such as executable files, libraries, configuration files, etc. for the destination system 100 to execute the application file. The generated filesystem image 220 may have a specified identification. The specified identification may include information including the location for the filesystem image 220 to be mounted in the filesystem 200 and a set of files to be utilized by the processor 101. In one aspect, the filesystem image 220 may include a script file to instruct the processor 101 on how to launch the application contained in the filesystem image 220. In some aspects, the filesystem image 220 may include an XML file that may dictate how to launch the application and any prerequisites that may need to be launched before the application is launched.

The filesystem image 220 may be transferred to the destination system 100 via the storage device 104 or the network interface 107. The filesystem image 220 may be mounted on the filesystem 200 in a read-only manner. In one aspect, the processor 101 may access the filesystem image 220 and associate the filesystem image 220 with a mounting point in the hierarchical filesystem 200 so that the processor 101 can locate files and/or directories in the filesystem image 220. If a standard location is present for any dynamically linked libraries in the filesystem 200, the processor 101 may set the library path to additionally include the location before launching the application inside the filesystem image 220. The filesystem image 220 may be read-only. Any additional configuration may be present outside the filesystem image 220. In one aspect, the additional configuration may be located in another specified location in the filesystem 200. Once the filesystem image 220 is mounted on the filesystem 200, the processor 101 may not modify the contents in the filesystem image 220.

At the beginning of the validity checking or verification process, the processor 101 may cryptographically verify the filesystem image 220. In one aspect, cryptographically processing data may include feeding, to a cryptographic process, values including the data an key, and carrying out the process in order to form cryptographically processed data. The cryptographic verification process may include detecting security vulnerabilities in a file, a directory, a file system, and combinations thereof. In one aspect, the cryptographic verification process may include validating cryptographically processed data, having an entry generated in a signature log for the data, where the entry includes cryptographic information associated with the data. For example, the filesystem image 220 may be cryptographically verified using generally available verification software such as the DM-Verity system created by Google for ChromeOS when the filesystem image 220 is mounted into the filesystem 200.

When one or more versions of the filesystem image 220 are present in the filesystem 200, during a start-up process of the destination system 100, the processor 101 may look for the latest version of the filesystem image 220 to use. When the latest version of the filesystem image 220 is determined and passes the verification process, older versions of the filesystem image 220 may be removed from the destination system 100.

In an aspect, if an application should be removed from the filesystem 200, the processor 101 may generate a specific file with the application name having a specific extension that the processor 101 may check before trying to mount a filesystem image 220. If the specified file is present in the filesystem 200, all the filesystem images 220 associated with the application may be removed and may not be mounted at a next start-up process of the destination system 100. For example, the processor 101 may look for an application that may match a given naming convention. For the application identified, the processor 101 may check for a specified application removal file. If the removal file is found, the processor 101 may remove all of the filesystem images 220 for this application. In addition, the processor 101 may check for a version indication file. In one aspect, the indication file may include a list of preferred versions in sequential order. If a preferred version is identified in the indication file, the processor 101 may verify the preferred version of the filesystem image 220. In one aspect, following the identification list, the processor 101 may iterate the checking and the verification processes in a sequential manner until a verified preferred version of the filesystem image 220 is identified. The processor 101 may iterate the checking, verification and mounting process for each of multiple applications.

The disclosure may include one or more communication channels that may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, a cellular telephone network, a Personal Communications Service (PCS), using known protocols such as the Global System for Mobile Communications (GSM), CDMA (Code-Division Multiple Access), W-CDMA (Wideband Code-Division Multiple Access), Wireless Fidelity (Wi-Fi), Bluetooth, Long Term Evolution (LTE), EVolution-Data Optimized (EVDO) and/or the like, and/or a combination of two or more thereof.

Further in accordance with various aspects of the invention, the methods described herein are intended for operation with dedicated hardware implementations including, but not limited to, personal computers (PC), personal digital assistants (PDA), semiconductors, application specific integrated circuits (ASIC), programmable logic arrays, cloud computing devices, and other hardware devices constructed to implement the methods described herein.

It should also be noted that the software implementations of the disclosure as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

The destination system 100 may be a computer, a smart phone, a mobile device, a machine (e.g., a fixed or mobile commercial machine, such as a construction machine, fixed engine system, marine-based machine, etc.) including an electronic control unit (ECU), or the like. An ECU may control one or more subsystems of a machine. For example, one type of ECU is an engine control module (ECM), which may control operations of a machine's engine. In one aspect, the destination system 100 may be integrated into an engine control module (ECM). For example, an ECM may control the quantity of fuel that is injected into each cylinder per engine cycle, ignition timing, variable valve timing, and operations of other engine components. Accordingly, the ECM controls or dictates the parameters by which the engine may operate. Similarly, other ECUs may control other subsystems of a machine, such as ECUs for controlling operation of a machine's transmission or anti-locking brake system. These ECU controls are implemented through software instructions.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated. All methods described herein can be performed in any suitable order unless otherwise indicated herein or otherwise clearly contradicted by context.

We claim:

1. A method for configuring a destination system, comprising:
generating, via a system, a filesystem image comprising an application file and files necessary for the destination system to execute the application file;
generating, via the system, a cryptographic signature file of the filesystem image;
configuring the filesystem image and the cryptographic signature file to be utilized by the destination system;
transferring the filesystem image and the cryptographic signature file to the destination system;
cryptographically verifying the filesystem image by the destination system; and
mounting the filesystem image on the destination system in a read-only manner.

2. The method according to claim 1, wherein the system is different from the destination system.

3. The method according to claim 1, wherein the destination system comprises a Linux-based filesystem.

4. The method according to claim 1, wherein the application file and files necessary for the destination system to execute the application file comprise at least any one of an application binary file, a library file, and a configuration file.

5. The method according to claim 1, further comprising:
generating, via the system, an identification name of the filesystem image to indicate a version of the filesystem image.

6. The method according to claim 1, further comprising:
cryptographically signing, via the system, the filesystem image.

7. The method according to claim 1, further comprising:
selecting and verifying, on the destination system, a preferred version among a plurality of versions of the filesystem image when the plurality of versions of the filesystem image are present in the destination system.

8. The method according to claim 1, further comprising:
removing, on the destination system, versions of the filesystem image that do not possess a cryptographic signature.

9. The method according to claim 1, further comprising:
cryptographically verifying, on the destination system, the filesystem image against change, due to tampering or corruption, via the cryptographic signature file.

10. The method according to claim 1, further comprising:
mounting the filesystem image into a filesystem of the destination system; and
integrating the destination system into an Engine Control Module (ECM).

11. The method according to claim 1, further comprising:
executing, on the destination system, the application file located in the filesystem image.

12. The method according to claim 1, further comprising:
preventing the destination system from modifying a content of the filesystem image once the filesystem image is mounted into a filesystem of the destination system; and
maintaining an original hierarchical file structure of the destination system while mounting the filesystem image into the filesystem of the destination system.

13. A device, comprising:
a filesystem comprising a hierarchical structure of directories, each of the directories capable of comprising files and sub-directories;
an operating system and files necessary for the device to operate an operating system, wherein the files necessary for the device to operate the operating system are stored in at least one of the directories;
a filesystem image comprising an application file and files necessary for the device to execute the application file, wherein an entire content of the filesystem image remains unmodified within the filesystem image in the device; and
a processor configured to operate the operating system and further configured to execute the application file within the filesystem image.

14. The device according to claim 13, wherein the processor is configured to access the application file while maintaining the entire content of the filesystem image unmodified.

15. The device according to claim 13, wherein the processor is configured to cryptographically verify the filesystem image.

16. The device according to claim 13, wherein the processor is configured to prevent the device from modifying the filesystem image.

17. The device according to claim 13, wherein the processor is configured to remove the filesystem image from the device.

18. The device according to claim 13, wherein the processor is configured to select and verify a preferred version among a plurality of versions of the filesystem image when the plurality of versions of the filesystem image are present in the device.

19. An apparatus for configuring a system, comprising:
filesystem means comprising an application file and files necessary for executing the application file in a device;
means for transferring the filesystem means to the device;
means for cryptographically verifying the filesystem means;
means for mounting the filesystem means on the device in a read-only manner; and
means for maintaining an entire content of the filesystem means once the filesystem means is mounted on the device.

20. The apparatus according to claim 19, further comprising:
means for generating an identification name of the filesystem means to indicate a version of the filesystem means;
means for generating a cryptographic signature file of the filesystem means;
means for cryptographically verifying the filesystem means with the cryptographic signature file;
means for selecting and verifying a preferred version among a plurality of versions of the filesystem means when the plurality of versions of the filesystem means are present in the device; and
means for removing non-verified versions of the filesystem means from the device.
